(19) United States
(12) Patent Application Publication
(10) Pub. No.: US 2015/0213154 A1
(43) Pub. Date: Jul. 30, 2015

(54) TRANSITIONING CAD MODEL DATA INTO VARIANT CONFIGURATIONS

(71) Applicants: Stephan Toebben, Walldorf (DE); Guido Hoeckele, Knittlingen (DE); Thomas Berger, Heidelberg (DE)

(72) Inventors: Stephan Toebben, Walldorf (DE); Guido Hoeckele, Knittlingen (DE); Thomas Berger, Heidelberg (DE)

(21) Appl. No.: 14/166,225

(22) Filed: Jan. 28, 2014

(51) Int. Cl. G06F 17/50

(52) U.S. Cl. CPC G06F 17/50

(57) ABSTRACT

A method for generating a product data structure for a configurable product may include receiving a computer-aided design (CAD) model including one or more configurations of the product. Model data may be extracted from the CAD model. The extracted model data may include geometric information of product items from each configuration of the product. The extracted model data may be provided in the product data structure including product item variants and instances associated with the variants. The instances may provide geometric information extracted from the CAD model.

### BACKGROUND

To remain competitive, companies offer highly variant products to their customers. These configurable products may have many variations of components and subcomponents with different possible combinations of these components. Product structure management systems allows for the companies to manage the product data structure of a product having many variations. The product data structure may integrate various configurations of the product, provide for viewing of the product configurations and provide details for manufacturing a specific product.

The customer may want to select the desired features of the product. For example, a customer buying a car may choose the features of the car. Variant configuration for the car may help the customer or salesperson to put together specifications for the desired configuration of the car and ensure that the car can be produced based on the selected specifications.

Computer-aided design (CAD) systems are used to model specific configurations of the product. The CAD models may provide a visual representation and geometric information of a specific configuration. For example, a CAD model of a product may be generated by an engineer to provide a visual representation of a car having specific features which could be selected by a customer. However, while the CAD model may provide information about a specific configuration of the product, this information is not used to generate or enhance the product data structure of a product.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates a block diagram illustrating a method for generating a product structure from a plurality of product configurations according to an embodiment of the present disclosure.

FIGS. 2A-2C illustrate hierarchical data structures of a configurable product according to various embodiments of the present disclosure.

FIG. 3 illustrates a method for generating a product data structure from one or more product configurations according to an embodiment of the present disclosure.

FIG. 4 illustrates a method for including new product models in a configurable data structure according to an embodiment of the present disclosure.

FIG. 5 illustrates a user interface for publishing model data into a product structure according to an embodiment of the present disclosure.

FIG. 6 illustrates an example computer system in which one or more embodiments of the present disclosure may be implemented as computer-readable code.

### SUMMARY

According to one exemplary aspect of the present disclosure, systems and methods are disclosed for generating a product data structure for a configurable product. The method for generating the product data structure may include receiving a computer-aided design (CAD) model including one or more configurations of the product. Model data may be extracted from the CAD model. The extracted model data may include geometric information of product items from each configuration of the product. The extracted model data may be provided in the product data structure including product item variants and instances associated with the variants. The instances may provide geometric information extracted from the CAD model.

### DETAILED DESCRIPTION

Embodiments of the present disclosure may be implemented as part of software providing a product data structure for a product life-cycle (e.g., a whole product life-cycle starting from early development phases to providing the product and product support to the customers) from a plurality of product configurations. In one example, the embodiments of the present disclosure may be implemented as part of a product configuration system using a hierarchical data structure. The product data structure may be generated based on information extracted from one or more CAD models.

The product data structure may provide configuration on instance level (e.g., geometric instances) and may include object dependencies on product variant item level and/or geometric instance level. The geometric instances may be created using information from the CAD model(s). A bill of material and bill of documents may be associated with components in the product data structure. In addition, viewable files may be created for each possible configuration. The information in the CAD model(s) may provide for the details needed to create the viewable files.

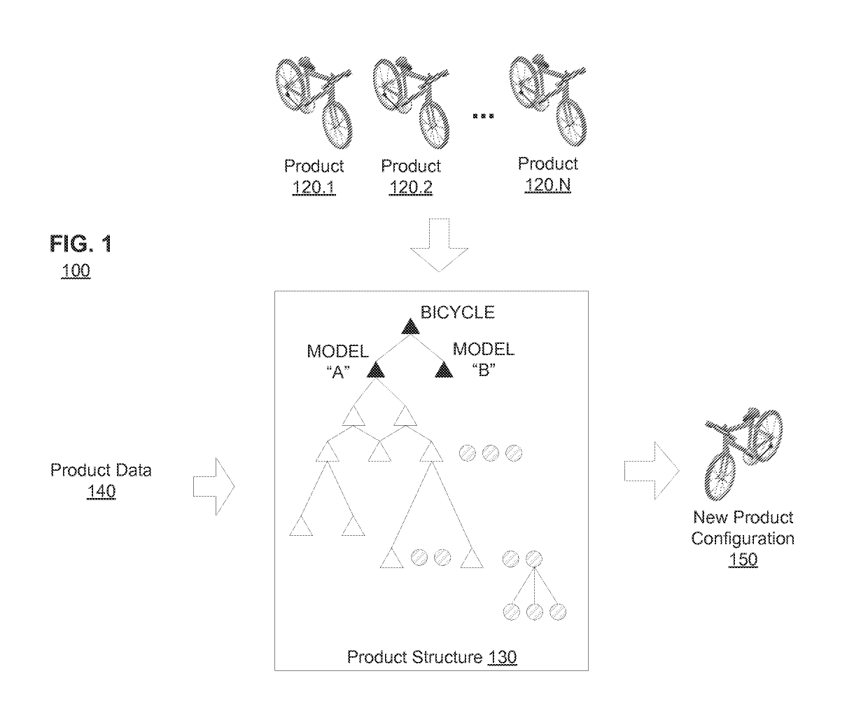

FIG. 1 illustrates a block diagram illustrating a method 100 for generating a product structure 130 using information from a plurality of product configurations 120.1-N according to an embodiment of the present disclosure. The method may include receiving a plurality of product configurations 120.1-N and generating a product structure 130 based on the product models 120.1-N. Additional product data 140 may be included in the product structure 130 to further define the product structure 130 (e.g., product component dependencies). A new product configuration 150 may be generated based on the data in the product structure 130.

The product structure 130 may provide possible variations of the product. The product structure 130 may include product variant items defining a one or more configurations of a product. Each product variant items may have an assigned material number and object dependency representing a rule set that defines if the item variant is relevant for a particular configuration. A defined configuration profile may be assigned to the product in the product structure 130.

The method may analyze the received product model configurations 120.1-N and extract information relating to the components and variations of these components from the model configurations 120.1-N. Based on this information the product structure 130 may be generated to provide the structure of the received product configurations 120.1-N. In addition to the structure of the received product configurations 120.1-N, the product structure 130 may provide additional possible product variations. These additional possible variations may be determined based on the received product configurations 120.1-N and/or the additional product data 140. The additional possible product variations may be used to generate the new product configuration 150.

The product structure 130 may be used to generate an engineering bill of materials (BOM) describing possible variations of a product. The product structure 130 may also provide the product with specific components and/or variations of the components. The product structure 130 may be used to derive a manufacturing BOM of a specific product configuration. The overall product structure 130 from which individual BOM may be generated may be referred to as a super BOM.

The product configurations 120.1-N may be a computer-aided design (CAD) model. Each product configuration 120.1-N may be provided in a separate CAD model or two or more product configurations 120.1-N may be provided as part of a single CAD model. The CAD model may include detailed engineering information about parts and assemblies of the parts. The CAD model information may include dimensions, interconnections, materials, processes, tolerances, functional relationships, material types, component names, and the like. The information from the CAD model may be extracted and included as part of the product structure 130. In one example, the geometric information of the components in the product configurations 120.1-N may be used to provide geometric instances of the variants in the product structure 130.

The new product configuration 150 may provide a configuration of the product that is not provided with one of the product configurations 120.1-N. The new product configuration 150 may combine components and/or variations of the components from multiple product configurations 120.1-N. For example, the new product configuration 150 may include a number of components or product variations from product configuration 120.1, which are not provided in product configuration 120.2. The new product configuration 150 may also include a number of components or product variations from product configuration 120.2, which are not provided in product configuration 120.1.

A user may provide additional product data 140 into the product structure 130. This information may be entered via a user interface. The additional product data 140 may be entered either before the product configurations 120.1-N are analyzed or after the product structure 130 is generated based on the product configurations 120.1-N. In one embodiment, the product structure 130 may initially be generated based on the product data 140 and the information from the product configurations 120.1-N may provide additional data (e.g., additional components, additional variations and/or restrictions on component combinations) to enhance the product structure 130. The product data 140 may include, for example, new configurations, components, variations, and/or restrictions. The restrictions may include restriction on combinations of component and/or variations.

The product structure 130 may include information for generating a visual representation of the possible configurations of the product. The information needed to provide the visual represented (e.g., geometric information) may be extracted from the product configurations 120.1-N. The visual representation of the product configuration may be generated for the configurations corresponding to the received product configurations 120.1-N and to new product configurations 150.

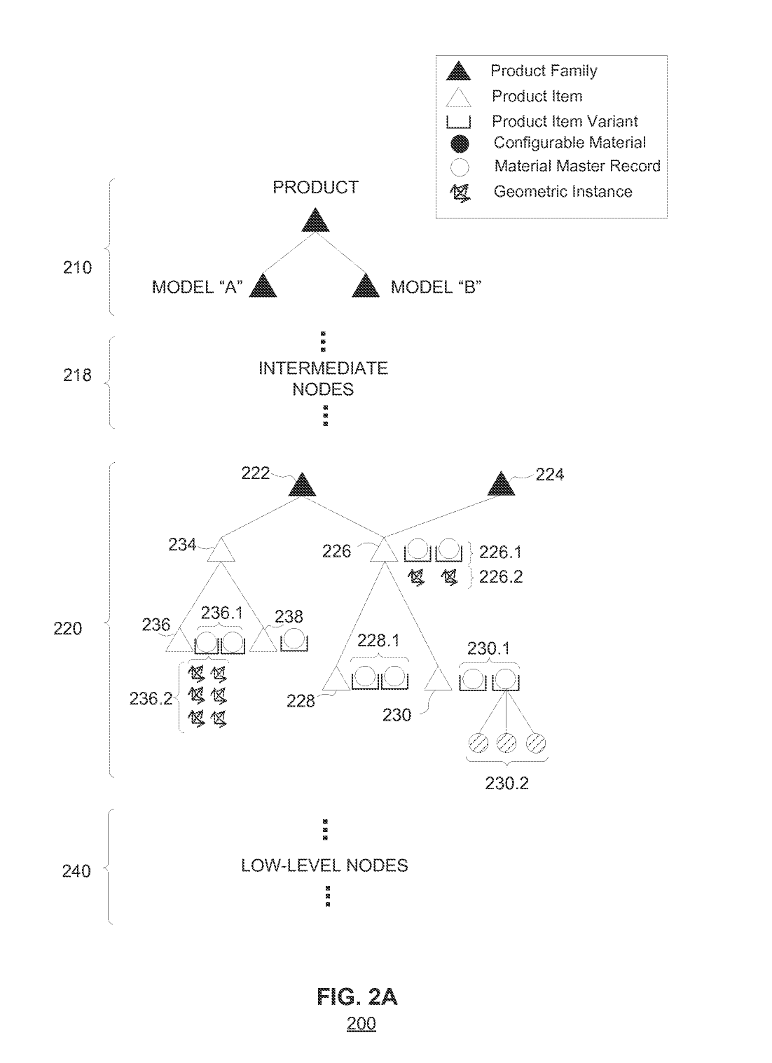

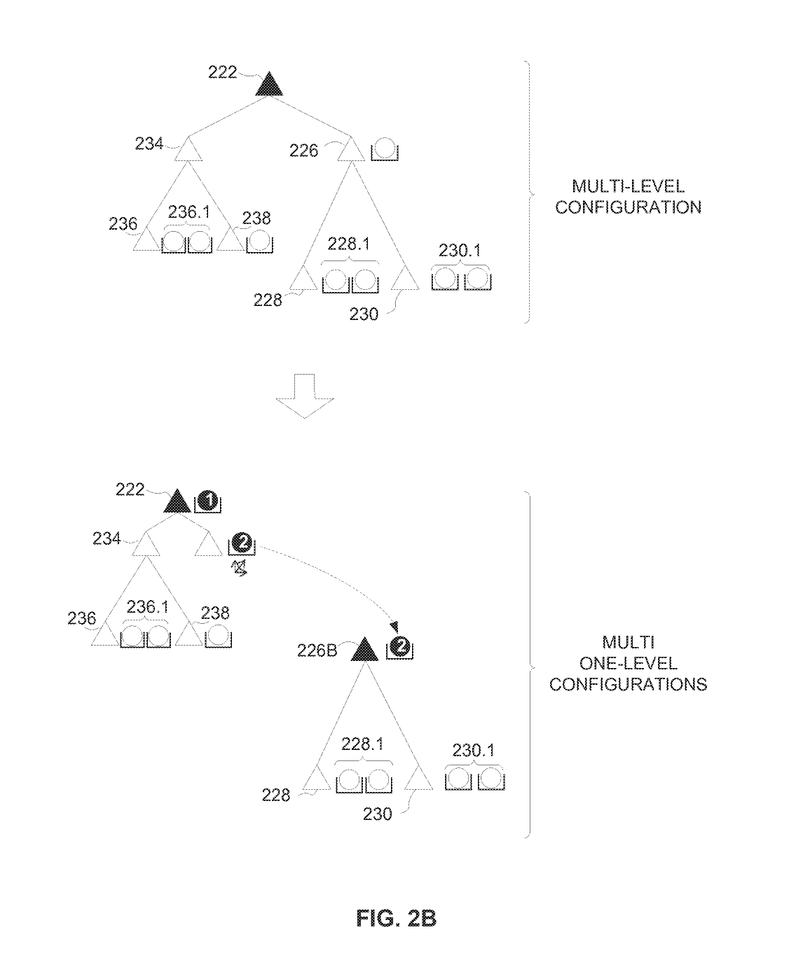

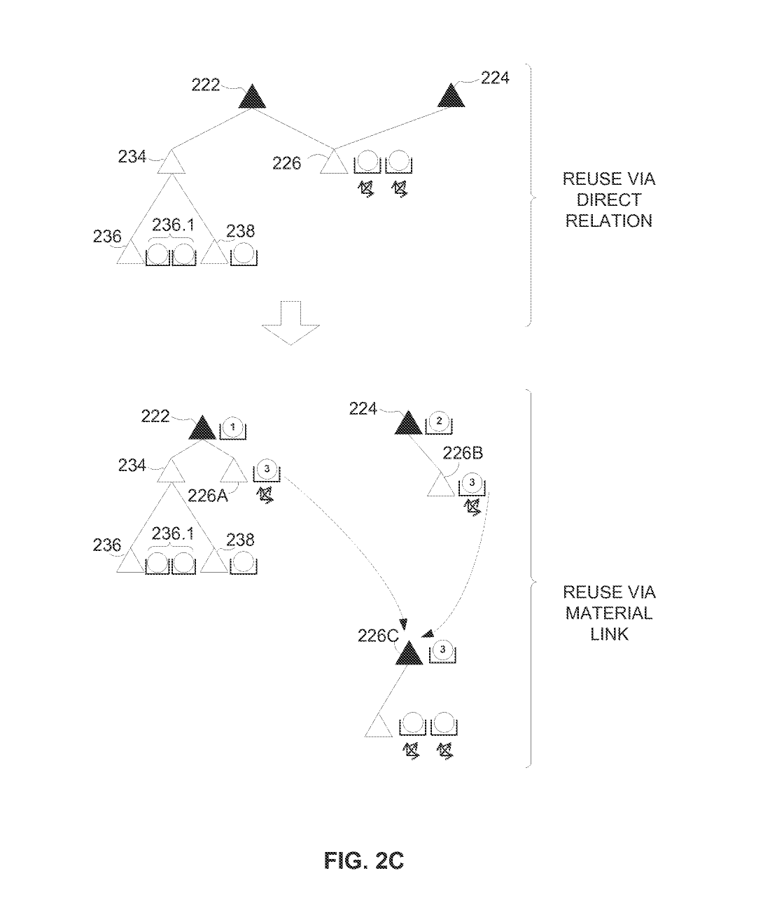

FIGS. 2A-2C illustrate hierarchical data structures 200 of a configurable product according to various embodiments of the present disclosure. The data structure 200 of the configurable product or material may provide for an end product with specific characteristics (e.g., components and variations of the components). A configured product or material may be produced from the configurable product and may include the specific configuration with a defined set of characteristic values. The characteristics in the end product may be tailored to specific customers or markets. A user may select the characteristics of the end product via a user interface.

The hierarchical data structures, shown in FIGS. 2A-2C, may be generated based on the data extracted from the product models (e.g., CAD models of the product) and/or additional data. The hierarchical data structures 200 may include existing product variations, product variations extracted from additional product models (e.g., CAD models), and additional product variations. The additional product variations may be derived based on the existing and extracted product variations. Thus, a higher degree of configurations can be provided in the hierarchical data structure 200, even for combinations which have not been explicitly created in the received product models (e.g., received CAD models).

In FIG. 2A, model “A”, model “B”, and nodes 222-238 may represent data structure 200 of an existing data structure that is enhanced with data from the received product model(s) (e.g., CAD model(s) of the product). One or more nodes in the data structure 200 may also include additional product variations derived based on the existing and extracted product variations.

The hierarchical data structure 200 may include a plurality of levels of nodes. The nodes may group variants having materials and object dependency assigned to them. The top level nodes 210 may represent an end product (e.g., bicycle) and high-level variants (e.g., model “A” and model “B”). The hierarchical data structure 200 may also include one or more intermediate nodes 218 and 220, below the high-level variants of nodes 210. The intermediate nodes 220 are shown with some particularity as an illustrative example. The hierarchical data structure 200 may also include low level of nodes 240 below the intermediate nodes 220. The data structure 200 may define a configurable level of a product. The nodes in the data structure 200 may correspond to product variant items that have configurable or non-configurable structures. The non-configurable structures of product variant items may be assigned via document BOMs or material BOMs.

As the hierarchical data structure 200 is traversed from high level nodes 210 to the low level nodes 240, the nodes may be viewed as representing components of the end product at progressively finer levels of granularity. For example, nodes 222 and 224 which may correspond to model “A” and model “B” in the top level nodes 210, may each generically represent a product family. The nodes 226-238 may represent the product items or components of the product family to which they are linked. In one example, the node 222 may represent a mountain bicycle and node 224 may represent a road bicycle. Node 226-230 may represent options (e.g., type of frame, wheels or handle bars) available on both the mountain bicycle model and the road bicycle model. The nodes 234-238 may represent options available on only the mountain bicycle model.

The variants of the product items may be represented by variants 226.1, 228.1, and 236.1. The variants 226.1, 228.1, and 236.1 may be associated with configurable materials and/or material master records. As shown in FIG. 2A, a material master may be provided for each product item variant. As shown in FIG. 2A, a configurable material may be provided in some of the product item variants. The configurable material may be a material master that is configurable. The configurable material may provide a configuration profile assigned which contains multiple characteristics.

The nodes 226-238 and their variants may include selection conditions associated with the nodes and/or the variants. The selection conditions may be user defined or may be incorporated from the model provided by the CAD models. The selection conditions may serve to prevent incompatible variants from being included in a specific product. In one embodiment, the nodes 226-238 may include low-level configurations and high-level configurations associated with the nodes and/or the variants. The low-level configurations may define selection condition for the variants (e.g., to prevent incompatible variants from being included in a specific product) and the high-level configurations may provide for sales process constraints. The sales process constraints may allow a user to restrict the possible combinations to maximize profit and/or reduce manufacturing time.

Instances of variants 226.2, 230.2 and 236.2 may be provided below one or more variants. The instances 226.2, 230.2 and 236.2 may provide for additional options and/or features of the product. The variants 226.2 and 236.2 may include a transformation matrix providing the location in space of the individual elements. The geometric dependencies of the object may be handled on the instance level by assigning the object dependencies to the instances.

The instances 236.2 may be grouped to reflect geometric deviations within one variant. An instance group may group instances that belong to the same visual configuration of the product. A single variant may include multiple instance groups. Depending on the configuration of the product, the same component may have different locations in space. Thus, the geometric variations may not be visible on the variant level but can be provided on the instance level. As shown in FIG. 2A, the variant 236.1 may include two groups of instances 236.2. Each group may include object dependency for different configurations of the variant. For example, a variant may represent an item being made out of two different materials. The first group of instances in 236.2 may provide geometric dependencies for the first type of material and the second group of instances in 236.2 may provide geometric dependencies for the second type of material.

The hierarchical data structure 200 may support reusable nodes. When the quantity and/or the transformation matrix are provided on the variant level and more specifically on the instance level, the nodes of the hierarchical data structure 200 may not be directly reused. Instead, the reuse components may be represented as its own data structure. A link between reused components may be provided via a material reference. With this embodiment, each reference of the product may have its own set of transformation matrices. Thus, each reusable component may be independent and allow for correct viewing of the component in the final product. FIGS. 2B and 2C illustrate examples of how the data structure 200 shown in FIG. 2A may be restructured to take account of these concepts.

FIG. 2B illustrates a multi-level configuration of a product data structure represented with multiple “one-level” configurations, such that each product family may have only one configurable level. As shown in FIG. 2B, the product family 222 in the multi-level configuration includes configurable variants at multiple levels (e.g., configurable variants at product item 226 and configurable variants at product items 228 and 230). Because product item 226 is configurable, a new product family 226B may be created. The material reference may be used to link the different product structures. The configurable material of the higher level product family (e.g., product family 222) may include all characteristics of the lower level product family (e.g., product family 226B) to provide the complete product configuration.

FIG. 2C illustrates a product data structure in which geometric instances may be valid for multiple product families. As shown in FIG. 2C, the reuse of the geometric instances by product families 222 and 224 with the direct relations may allow for the geometric instance to be valid for only one of the product families. The product data structure with the direct relations may be rearranged to reuse the components via a material link. The product item 226 in the direct relations may be provided as a new product family 226C having a separate structure with material links to the product items 226A, 226B in each product family 222 and 224. Each product family may have its own set of configuration possibilities (e.g., its own class and characteristics).

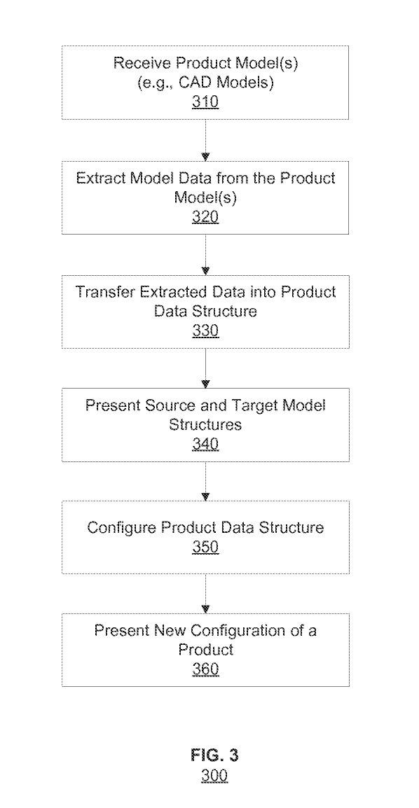

FIG. 3 illustrates a method 300 for generating a product data structure from one or more product configurations according to an embodiment of the present disclosure. The method 300 may include receiving one or more product models (block 310), extracting model data from the product model(s) (block 320), transferring extracted data into a product data structure (block 330), presenting source and target model structures (block 340), configuring the product data structure (block 350), and present new configuration of a product (block 360).

Receiving one or more product models (block 310) may include receiving one or more product models (e.g., CAD models) of a product, each model providing the product with different characteristics (e.g., configurations, components and/or features). In one embodiment, a different CAD model may be provided for each product model. In another embodiment, a single CAD model may include a plurality of configurations of the product. The CAD model data may include dimensions, interconnections, materials, processes, tolerances, functional relationships, material types, component names, and the like. The CAD model may be generated using 2D or 3D design software which may include, CATIA®, Unigraphics®, I-Deas®, AutoCADC), Pro-Engineer®, Solid Works®, Allias®, Mya®, Alibra®, TogoCAD®, CAD II®, and/or Computer-aided engineering (CAE) software which may include Nastran®, Hyermesh®, CATIA®, LS-Dyna®, AIGore®, AnI®, Fire®, and Enovia®.

Extracting the model data from the product model(s) (block 320) may include extracting the geometric information from the product models for each of the product configurations. The geometric information from each model may be included in a parts list with relationships of the parts to each other. The extracted data for each model may include at least one of part names or number (e.g., material ID), type of materials for each part, and location of each part. Bill of documents and/or a bill of material may be generated based on the extracted model data for each model. The bill of documents and/or a bill of material for each model may provide a non-configurable structure. The extracted data (e.g., material ID) may be linked to the file from which the data is extracted.

Transferring the extracted data into the product data structure (block 330) may include inserting the extracted model data into the product data structure. In one embodiment, the extracted data may correspond to a specific configuration of the product. The extracted data may be loaded into a non-configurable layer and/or configurable layer of the product data structure. The non-configurable layer may provide for components that do not have multiple characteristics. The configurable layer may provide for components that include multiple characteristics (e.g., multiple variants and/or instances). In one embodiment, the extracted model data may form a new product data structure including nodes, variants and instances. In another embodiment, the extracted model data may supplement an already existing product data structure. Thus, the extracted model data may add additional nodes, variants and instances which are not already in the product data structure. In one embodiment, the extracted model data may be added only to the configurable layer of the product data structure.

The source model structure(s) and the target model structure of the product may be presented (block 340) to the user in a user interface. The source model may correspond to a configuration represented by the CAD model. The target model may correspond to the configurable product data structure that includes the one or more possible configurations of the product. The source and target structures may be presented by their 3D models and/or as a visual data structure (e.g., hierarchical tree structures). The geometric information between the two structures may be matched to support the user in assigning instances from the CAD model to the product data structure. The geometric information between the two structures may be considered identical if the models have the same components (e.g., identified by a material number) and the same position in space.

In one embodiment, a user interface may display a source model, a target model (e.g., one configuration of the product), and a super BOM (e.g., data relating to all possible configurations) displayed in a tree structure. The extracted data from the source model may be entered into the super BOM and the selected nodes may be shown in the target model (e.g., via a 3D model). The differences between the source model and the target model may be highlighted in one or both models.

Configuring the product data structure (block 350) may include assigning geometric information from the source structure(s) to the target structure. As the geometric information is assigned to the target structure, the items in the bill of materials and/or the variants in the product data structure may be updated. Configuring the product data structure (block 350) may include updating existing components and/or creating new components. In one embodiment, configuring the product data structure may include assigning object dependency. The object dependencies may include describing the relationships between components and their characteristics. The characteristic may include properties describing and distinguishing between objects (e.g., length, color and weight).

A new configuration of the product may be presented (block 360) based on the configured product data structure. This step may include presenting a bill of material for an existing configuration (e.g., configuration provided by the CAD model) or for a new configuration. The new configuration of the product may correspond to a configuration that is not provided by the received product models. The new configuration of the product may be presented as a 3D model and/or as a data structure (e.g., tree structure). The new configuration of the product may be presented based on the data in the product data structure.

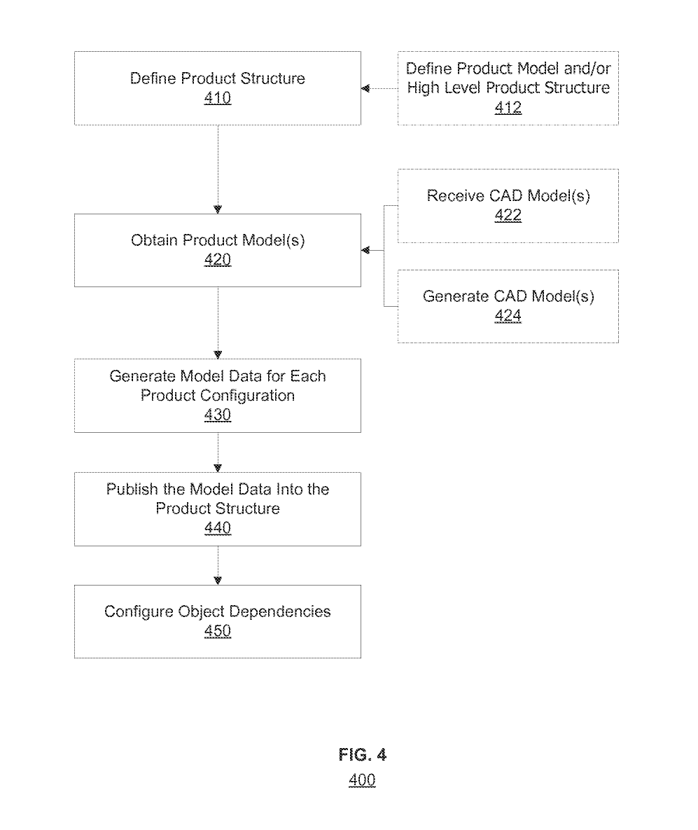

FIG. 4 illustrates a method 400 for including new product models in a configurable data structure according to an embodiment of the present disclosure. The method 400 may include defining product structure (block 410), obtaining product models (block 420), generating model data for each product configuration (block 430), publishing the model data into the product structure (block 440), and configuring object dependencies (block 450).

Defining the product structure (block 410) may include defining a product model and/or high level product structure for configurable products (block 412). Defining the product structure (block 410) may provide the basic characteristics of the configurable product and may include one or configurations of the product. All of the possible configurations of the product may not be defined in this step. In one embodiment, defining the product structure may include providing definitions of the product model and the product structure for each reusable component. Each reusable component may represent its own product structure. The structures may be linked via a material master provided for the configurable material.

Defining the product model may include defining settings in the product master data and may include defining one or more of class, characteristics of the class, characteristic values and descriptions, configurable material, configurable profile, and high level object dependencies. The class of the product model may define characteristics of the product(s) and may group similar product according to common characteristics. The configurable materials may correspond to materials that have different variants (e.g., bicycle can have different types of paintwork and handles). The configurable profile may be created for the configurable material. The object dependencies may include describing the relationships between objects and their characteristics. The characteristic may include properties describing and distinguishing between objects (e.g., length, color and weight). The dependencies may be defined using Boolean rules. The object dependencies may be assigned to the product components (e.g., product variant items, instances or instance groups). When a specific product configuration is selected, an evaluation may be performed to determine if based on the object dependencies assigned to a variant item is relevant for the selected configuration.

Defining the high level product structure for the configurable product may include creating a new product family assigned to a defined product class, creating product variants, and creating product items to represent the product functions. Defining the high level product structure may also include creating product item variants representing the functional variants of the product. In one embodiment, defining the high level product structure may also include maintaining object dependences for the product item variants to separate the product item variants via characteristics of the product model.

Obtaining product models (block 420) may include receiving a completed product model (e.g., file containing the product model(s)) (block 422) or generating a product model outside of the defined product structure (block 424). The product model, which may be a CAD model, may be generated by a CAD designer using 2D or 3D design software or computer-aided engineering software. The product model may include multiple configurations within each product model (e.g., multiple configurations in each CAD model). The software for generating the CAD model may be different from the software for providing the product data structure of the configurable product.

Generating the model data for each product configuration (block 430) may include analyzing the received product model(s) and generating data describing the product model(s). The model data may include one or more of, viewable file of the configuration, material numbers, and original model data. The generated data describing the product models may be provided in a format that can be included as part of the product structure (e.g., product structure created in block 410).

Generating the model data for each product configuration (block 430) may include providing a fully resolved Bill of Documents (BOD) for each configuration in the product model(s) and/or a generic BOD with the original model data (e.g., original CAD model files). Generating the model data may include generating a document info record which represents the original CAD structure and a document info record providing a viewable model of a single configuration. A document info record providing a viewable model of a single configuration may be provided for each configuration. The viewable model may be generated by a lightweight visual generator (e.g., SAP® Visual Enterprise Generator) that can process CAD and other 2D and 3D graphics and generate a lightweight format for downstream use, enabling nontechnical users to search, access, manipulate, and integrate complex graphical data into any business or office application across your organization. The viewable model may be stored for later visualization.

Generating the model data for each product configuration (block 430) may also include creating a material master for each configured part in the model and/or assembly. In each configuration, a different material number may be generated for each part. Each material master may include an object link to the Document Info Record (DIR) including the generic original model and an object link to DIR with the viewable file to the specific configuration.

In one embodiment, the CAD models may be provided to an Enterprise Resource Planning (ERP) system and the ERP data may store the CAD models and the data generate based on the CAD models. This data may include the BOD data, DIR data and the material master data.

Publishing the product model(s) data into the product structure (block 440) may include connecting the relevant CAD data (e.g., geometric data) and the extracted CAD data (e.g., materials and document info records) to the defined product structure. In this step, the existing product structure may be enriched with the model data from the product models. The product structure may be enriched with, for example, product variants and/or geometric data (e.g., instances) from the model data.

In one embodiment, publishing the model data into the product structure (block 440) may include exporting relevant data from the product model(s) and assigning the exported data to the data structure. Exporting the relevant structure and document information from the CAD model(s) may include extracting the relevant structure and document information from the CAD model(s). The relevant structure data may include data for providing a visual representation of the model, for example, in a visual enterprise instance planner. The displayed data in the visual enterprise instance planner may be linked to the product structure.

In one embodiment, the user may select parts of the structure in one product model and assign them to portions of the product structure. This may be repeated for each part and/or for each product model. In one embodiment, the user may select a part in the visual enterprise instance planner, drag the selected part to a visual representation of the product structure, and drop the selected part into a portion of the product structure. With this process, the product structure may be enriched with geometric information (e.g., instances) from the parts of the specific product model. In addition, the product structure may be enriched with the material master and document info records carrying a viewable file for later visualization.

In one embodiment, the instances may be assigned to variants with the same material ID and document ID. The instances may be assigned to variants that are configurable. Similarly, the instances may be assigned only to instance groups that are configurable. In this embodiment, the instance groups that are not configurable may not be changed. An instance may be considered identical between the source and target structure if they have the same material ID and the same position in space (e.g., transformation matric).

Configuring object dependencies (block 450) may include providing object dependencies for the new variants and/or instances. This step may also include updating the object dependencies for existing variants and/or instances. In one embodiment, the dependencies for the new variants and/or instances may be set based on previous dependency settings. For example, the existing setting for a variant may be extended to the new instances. In another embodiment, new dependencies may be set for the existing and new variants and/or instances.

The product structure including the model data from one or more product models may provide multiple configuration of the product. A selection may be made of a configuration and released to, for example, a manufacturer. The specific configuration may be provided with a bill of material for the configuration. The product structure may also be provided to a customer to select the desired product configuration based on the available options in the product structure.

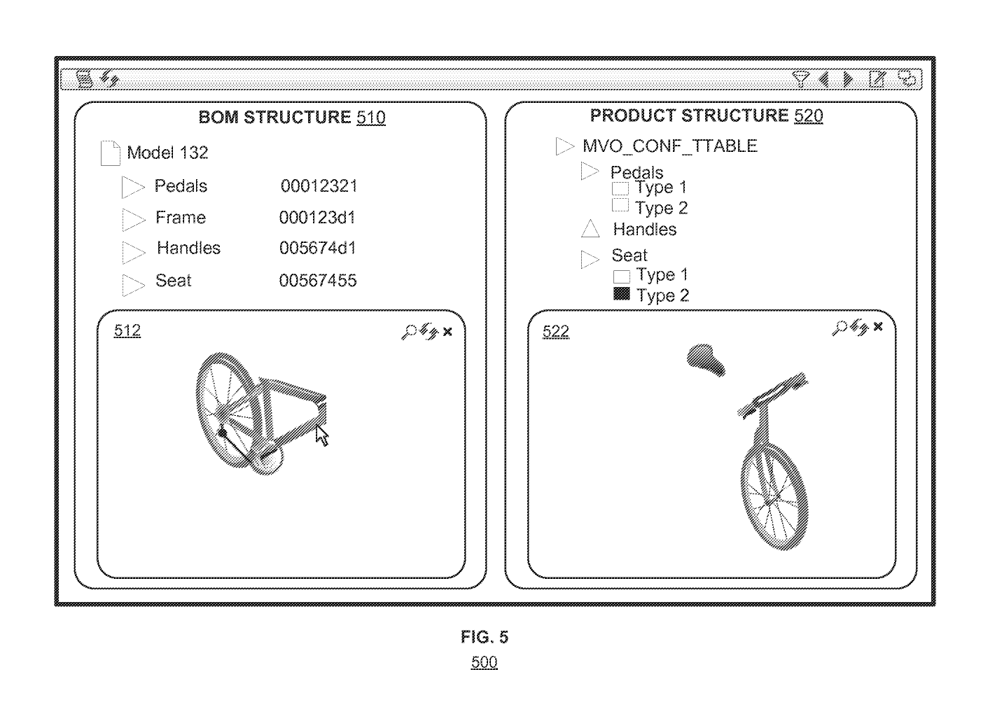

FIG. 5 illustrates a user interface 500 for publishing model data into a product structure according to an embodiment of the present disclosure. The user interface 500 may include a display 510 for the BOM of a product model and a display 520 for the product structure. The display 510 may include a visual display 512 (e.g., a 2D or 3D model) of the product model. Similarly, the display 520 may include a visual display 522 (e.g., a 2D or 3D model) of the selected product structure.

If more than one product models are available a user may select one of the available product models to be displayed in the display 510. Based on the selected product model the BOM of the product model may be displayed. The display 512 may include a 3D viewable of a selected product configuration from the available product models.

In the display 520 the complete product structure may be displayed (e.g., via tree structure). If a configuration is specified, the product item variants in the display 520 may be marked as configurable or as not configurable. If no configuration is selected, all of the variants may be marked as not configurable. A user may change the settings of variants between configurable and not configurable. The not configurable variants may be at least partially hidden in the display 520. The display 522 may display a selected configuration of the product based on the information in the product structure and allow the user to switch between multiple configurations. Based on a user selection of a configuration, the complete product structure in display 520 may be filtered to identify variant items that belong to the selected configuration. In one embodiment, the variant items that belong to the selected configuration may be identified by a check mark. Variants that do not have object dependency assigned (e.g., no selection rules) may be identified (e.g., made fully visible) in the complete product structure of the display 520. The variants that do not have object dependency assigned may be part of every possible configuration.

A user may select items in the display 510 (e.g., from the BOM or from the 3D model) and assign them to configurable variants in the product structure. Assigning the items to the product structure in display 520 may create geometric instances of the item in the corresponding variants. As items are assigned to the product structure, the display 522 may display a 3D rendering of the assigned parts. Once a part is assigned to the product structure, the part may no longer be displayed in display 512. This may provide the user with the current state of the assigned and not assigned parts of the model.

When a user selects a part in the BOM of display 510 and provides the part in the product structure of display 520, a new product item variant may be created in the product structure. In addition, a new geometric instance may be created and linked to the product item variant. In one embodiment, a material master and/or document information record may also be assigned to the product item variant.

If a product item variant is already created in the product structure, the selected item may be associated (e.g., dropped) on an existing variant. In this case, a new geometric instance may be created and linked to the product item variant. In addition, a material master and/or document information record may be assigned to the product item variant. The user interface may ask the user if an instance group should be created when multiple instances are associated with a product item variant.

In one embodiment, the method may automatically match variants and instances between the product model in display 510 and the product structure in display 520. The matching may be done based on one or more of, item material and geometric information (e.g., shape, size or position). The matching instances or variants may be hidden in the product model of display 510 and shown in the product structure of display 520. With automatic matching, the method may match instances from the source model to the target model and generate new variants and/or instances if matches are not found. If multiple matches are found a user decision may be request to determine which match is correct.

The not matching variants and instances that are configurable may be indicated as not matching in the product model of display 510 and/or the product structure of display 520. In one embodiment, the not matching variants and instances may not be shown in the 3D models. In this embodiment, the not matching variants and instances may only be shown in the product model tree of display 510 and/or the product structure tree of the display 520. However, the user may have an option to display the non-matching variants and instances in the 3D model of the displays 512, 522. The non-configurable variants may be directly loaded into the displayed 3D model.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

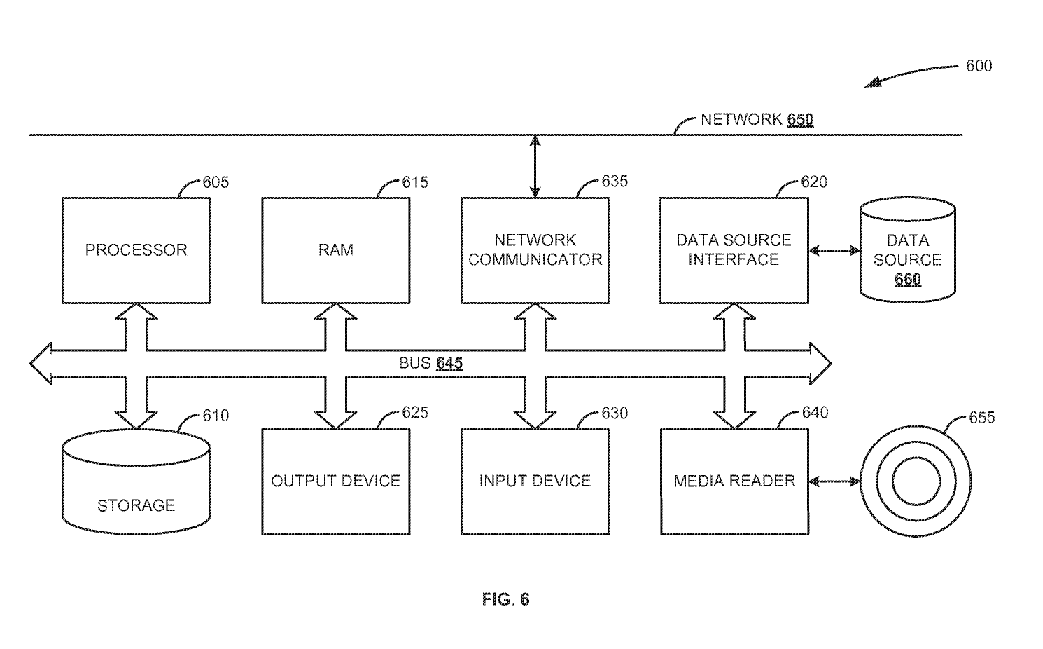

FIG. 6 is a block diagram of an exemplary computer system 600. The computer system 600 includes a processor 605 that executes software instructions or code stored on a computer readable storage medium 655 to perform the above-illustrated embodiments of the disclosure. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the disclosure, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the various embodiments can be practiced without one or more of the specific details or with other methods, components, techniques, etc. In other instances, well-known operations or structures are not shown or described in detail to avoid obscuring aspects of the disclosure.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments of the disclosure, including what is described in the Abstract, is not intended to be exhaustive or to limit the embodiments to the precise forms disclosed. While specific embodiments of, and examples for, the embodiments are described herein for illustrative purposes, various equivalent modifications are possible within the scope of the disclosure, as those skilled in the relevant art will recognize. These modifications can be made to the embodiments in light of the above detailed description.

What is claimed is:

1. A method for generating a product data structure for a configurable product, the method comprising:
receiving a computer-aided design (CAD) model, the CAD model including one or more configurations of the product;
extracting model data from the CAD model, the extracted model data including geometric information of product items from each configuration of the product; and
providing the extracted model data in the product data structure, the product data structure including product item variants and instances associated with the variants, the instances providing geometric information extracted from the CAD model.

2. The method of claim 1, further comprising presenting, in a user interface, a source model corresponding to one configuration provided in the CAD model and a target model corresponding to at least one configuration in the product data structure.

3. The method of claim 2, further comprising receiving a request from the user to transfer product item variants from the source model to the target model.

4. The method of claim 3, wherein, if a product item variant is already created in the product data structure that corresponds to the transferred product item variant, in response to the transfer request a new geometric instance is created and linked to the corresponding product item variant in the product data structure.

5. The method of claim 2, wherein the user interface displays the source model and the target model using a three dimensional model.

6. The method of claim 1, further comprising automatically matching product item variants in one configuration provided in the CAD model and the product item variant in the product data structure, wherein the matching is performed based at least on one of material ID and position of the product item in space.

7. The method of claim 6, wherein a new product item variant is created in the product data structure if the product item variant from the CAD model does not match an existing product item variant in the product data structure.

8. The method of claim 1, further comprising generating a material Bill of Material (BOM) for a specific configuration of the product based on the product data structure.

9. The method of claim 8, wherein the specific configuration is different from the configurations provided by the CAD model.

10. The method of claim 8, wherein the specific configuration is displayed as a three dimensional model in a user interface based on the information provided in the product data structure.

11. A method for generating a product data structure for a configurable product, the method comprising:
defining a high-level product data structure providing one or more configurations of the configurable product, the high-level product data structure including one or more product families defining a product class, product item variants associated with the product family, and instances associated with the product item variants;
receiving a computer-aided design (CAD) model, the CAD model including one or more configurations of the product, wherein at least one of the configuration is different from the configurations provided in the high-level product data structure;
generating model data from the CAD model, the model data including a viewable file of each configuration provided in the CAD model and geometric information of product items from each configuration of the product; and
providing the generated model data in the high-level product data structure.

12. The method of claim 11, further comprising providing object dependencies for product item variants in the product data structure based on the generated model data.

13. The method of claim 11, wherein providing model data in the high-level product data structure includes enriching the high-level product data structure with additional product items and product item variants from the CAD model.

14. The method of claim 13, further comprising providing object dependencies for the additional product item variants in the product data structure.

15. The method of claim 11, further comprising presenting, in a user interface, a source model corresponding to one configuration provided in the CAD model and a target model corresponding to at least one configuration in the high-level product data structure.

16. The method of claim 15, further comprising receiving a request from the user to transfer product item variants from the source model to the target model.

17. The method of claim 16, wherein, if a product item variant is already created in the product data structure that corresponds to the transferred product item variant, in response to the transfer request a new geometric instance is created and linked to the corresponding product item variant in the product data structure.

18. The method of claim 11, further comprising generating a material Bill of Material (BOM) for a specific configuration of the product based on the product data structure, wherein the specific configuration is different from the configurations provided by the CAD model.

19. A system for executing a computer program to generate a product data structure for a configurable product, the system comprising:
a memory device storing the computer program and the product data structure; and
one or more processors that perform the method of claim 11.

20. A non-transitory computer readable medium containing program instructions, wherein execution of the program instructions by one or more processors of a computer system causes one or more processors to carry out the steps of:
defining a high-level product data structure providing one or more configurations of a configurable product, the high-level product data structure including one or more product families defining a product class, product item variants associated with the product family, and instances associated with the product item variants;
receiving a computer-aided design (CAD) model, the CAD model including one or more configurations of the product, wherein at least one of the configuration is different from the configurations provided in the high-level product data structure;
generating model data from the CAD model, the model data including a viewable file of each configuration provided in the CAD model and geometric information of product items from each configuration of the product;
providing the generated model data in the high-level product data structure, wherein providing model data in the high-level product data structure includes enriching the high-level product data structure with additional product items and product item variants from the CAD model;
providing object dependencies for product item variants in the product data structure and object dependencies for the additional product item variants in the product data structure based on the generated model data;
presenting, in a user interface, a source model corresponding to one configuration provided in the CAD model and a target model corresponding to at least one configuration in the high-level product data structure; and
receiving a request from the user to transfer product item variants from the source model to the target model.
